(19) United States
(12) Patent Application Publication
(10) Pub. No.: US 2007/0067603 A1
(43) Pub. Date: Mar. 22, 2007

(54) Nonvolatile memory device and the method of generation of the address translation table

(76) Inventors: Yasunori Yamamoto, Tokyo (JP); Tatsuya Yamashita, Tokyo (JP); Masashi Wada, Tokyo (JP); Takeshi Nakamura, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/521,387

(22) Filed: Sep. 15, 2006

(30) Foreign Application Priority Data
Feb. 1, 2006 (JP) 2006-024305
Sep. 16, 2005 (JP) 2005-270067

(51) Int. Cl. G06F 12/00

(52) U.S. Cl. 711/207

(57) ABSTRACT

The initialization operation time is substantially reduced to realize a high-speed nonvolatile semiconductor memory. A memory array of a nonvolatile semiconductor memory includes a data storage area in which data is stored, a program storage area in which programs are stored, and a table block in which an address translation table for the program storage area is stored. When the program storage area is set at power-on reset of a memory device, an address translation table of the table block is read and the status is ready in which another program storage area is readable. Subsequently, an address translation table for a relevant data storage area is generated by performing an initialization operation of the data storage area, and thus to make the data storage area accessible.

### CROSS-REFERRENCE TO RELATED APPLICATION

The present application claims priority from Japanese Patent Applications No. 2006-024305 filed on Feb. 1, 2006, and No. 2005-270067 filed on Sep. 16, 2005, the content of which is hereby incorporated by reference into this application.

### BACKGROUND OF THE INVENTION

The present invention relates to a high-speed operation technology in a memory device, and more particularly to a technology which is effectively applicable to a reduction of power-on reset process time in a nonvolatile semiconductor memory.

Memory cards such as, for example, Multimedia Card (registered trademark in Japan) and CF (Compact Flash) Card have been widely used as memory devices for personal computers and multifunctional terminals.

With the recent demand for high performance capabilities, there has been used a nonvolatile semiconductor memory such as, for example, a flash memory which is electrically block-erasable and rewritable to store a large amount of data, as a semiconductor memory to be installed to the memory card.

In such a nonvolatile semiconductor memory, it is known that having an address translation table for managing translation from a logical address specified by a host device to a physical address of the nonvolatile semiconductor memory.

The address translation table is generated, for example, for each initialization operation (power-on reset operation) of the nonvolatile semiconductor memory. The generated address translation table is stored to the semiconductor memory such as a work RAM (Random Access Memory) provided in a controller for controlling the nonvolatile semiconductor memory.

[Related patent list]

(1) U.S. Pat. No.:5,644,539
(2) U.S. Publication No.: 20040065744
(3) U.S. Pat. No.: 6,788,575

### SUMMARY OF THE INVENTION

However, the present inventors have found the following problem in the technology to generate the address translation table for the nonvolatile semiconductor memory as described above.

The problem is that because it is necessary to read management data in all blocks of a memory array when generating the address translation table, the initialization time for the nonvolatile semiconductor memory is increased. This could impair the high-speed capabilities of the nonvolatile semiconductor memory. On the other hand, it is possible that the all address translation table was stored in the nonvolatile semiconductor memory and was read out to the work RAM in the initialization operation. However, the rate of the memory capability for the user in the all amount of the memory capability is substantially decreased, because the amount of the memory area has become huge then the size of the address translation table has enlarged.

The object of the present invention is to provide a technology that can substantially reduce the initialization operation time to realize a high-speed nonvolatile semiconductor memory.

The foregoing and other objects as well as novel features of the invention will become apparent from the description to be made with reference to the accompanying drawings.

Typical inventions disclosed in the present application will be outlined as follows.

The invention is a semiconductor circuit device including a nonvolatile semiconductor memory having a plurality of nonvolatile memory cells and capable of storing given information, and a controller for providing operation instructions for the nonvolatile semiconductor memory based on commands issued from the outside. The nonvolatile semiconductor memory has an memory area including an area set to for example a first status used for program storage in which data is not allowed to be updated, an area set to for example a second status used for data storage in which data is allowed to be updated, and a table block for storing the address translation table in which a logical address supplied from the outside is mapped to each physical address of the area set to the first status. The controller stores to the table block the address translation table for the area set to the first status, which has been generated before the initialization operation, and generates the address translation table for the area set to the second status for each initialization operation.

Further, according to the invention, the area set to the first status and the area set to the second status are provided in different strings, respectively.

Further, according to the invention, the controller sets the area set to the first status to an arbitrary area in predetermined units.

Further, according to the invention, the controller performs the area setting of the area set to the first status based on a command input from the outside.

Further, according to the invention, the controller allows access to the area set to the first status upon reading the address translation table for the area set to the first status, which is stored in the table block.

Further, according to the invention, the area set to the second status of the nonvolatile semiconductor memory is randomly divided into a first area and a second area. The controller generates the address translation table for the first area for each initialization operation, and generates the address translation table for the second area based on a command input from the outside.

Further, according to the invention, the controller receives a read command that is input from the outside to read the data of the area set to the first status during the generation of the address translation table in the area set to the second status, and performs the generation of the address translation table and the reading of data from the area set to the first status, in a time-sharing manner.

Further, according to the invention, the controller generates the address translation table in the area set to the second,status, in a second access for transferring the data read from the area set to the first status upon reception of the read command input from the outside, to the outside from a read buffer that temporality stores the data read from the nonvolatile semiconductor memory.

Other inventions disclosed in the present application will be briefly outlined.

The invention randomly divides a memory area of a nonvolatile semiconductor memory into an area set to a first status and an area set to a second status. For the case of area set to the first status, it generates an address translation table in which a logical address supplied from the outside is mapped to each physical address of the area set to the first status, before an initialization operation, and stores to the memory area. For the case of the area set to the second status, it generates an address translation table for each initialization operation.

Further, the invention performs the area settings for the first status and the area set to the second status to different strings, respectively.

Further, the invention performs the area setting for the area set to the first status in units of strings.

Further, the invention performs the area setting for the area set to the first status based on the command input from the outside.

Further, the invention reads the address translation table for the area set to the first status, which is stored in the memory area, in the initialization operation, to enable access to the area set to the first status, and then generates the address translation table for the area set to the second status.

Further, the invention randomly divides the area set to the second status of the nonvolatile semiconductor memory into the first area and the second area, generates the translation table for the first area for each initialization operation, and generates the address translation table for the second area based on a command input from the outside.

Further, the invention receives a read command input from the outside to read the data of the area set to the first status during the generation of the address translation table in the area set to the second status, and performs the generation of the address translation table and the reading of data from the area set to the first status, in a time-sharing manner.

Further, the invention generates the address translation table in the area set to the second status, in the second access for transferring to the outside the data read from the area set to the first status upon reception of the read command input from the outside.

The following is a brief description of effects obtained by typical inventions disclosed herein.

(1) It is possible to substantially reduce the initialization operation time in a semiconductor integrated circuit device having a nonvolatile semiconductor memory.

(2) For the reason described in the above (1), it is possible to improve the performance of the semiconductor integrated circuit device.

### BRIEF DESCRIPTION OF THE DRAWINGS

FIG. 1 is a block diagram of a memory device according to a first embodiment of the invention;

FIG. 2 is a diagram illustrating a memory array configuration in a nonvolatile semiconductor memory provided in the memory device of FIG. 1;

FIG. 3 is a diagram illustrating an example of a memory area configuration in the memory array of FIG. 2;

FIG. 4 is a diagram illustrating an example of management information data definitions in management sections provided in the memory array of FIG. 3;

FIG. 5 is a diagram illustrating a status transition in the setting of a program storage area to the memory array of FIG. 3;

FIG. 6 is a timing chart showing a signal cycle for setting the program storage area to the memory array of FIG. 3;

FIG. 7 is a timing chart showing a signal cycle in a PSA Lock status after the setting of the program storage area in the memory array of FIG. 3;

FIG. 8 is a timing chart showing a signal cycle for performing PSA Unformat of the memory array of FIG. 3;

FIG. 9 is a timing chart showing a signal cycle for performing PSA Unlock of the memory array of FIG. 3;

FIG. 10 is a flowchart showing an example of a PSA Format process in the memory device of FIG. 1;

FIG. 11 is a flowchart showing an example of a PSA Lock process in the memory device of FIG. 1;

FIG. 12 is a flowchart showing an example of a PSA Unlock process in the memory device of FIG. 1;

FIG. 13 is a flowchart showing an example of a PSA Unformat process in the memory device 1 of FIG. 1;

FIG. 14 is a flowchart showing an example of a power-on reset process and a status of the program storage area, in the setting of the program storage area in the memory device of FIG. 1;

FIG. 15 is a flowchart showing an example of an initialization process of the data storage area in the memory device of FIG. 1;

FIG. 16 is a block diagram showing an example of an electronic system configured by using the memory device of FIG. 1;

FIG. 17 is a diagram showing an example of an address translation table generated at power-on reset of the memory device according to a second embodiment of the invention;

FIG. 18 is a flowchart showing an example of a process for generating the address translation table at power-on reset of FIG. 17;

FIG. 19 is a flowchart showing an example of a process for generating the address table after the generation of the address translation table of FIG. 18;

FIG. 20 is a diagram illustrating an example of an address translation table generated at power-on reset of the memory device according to another embodiment of the invention;

FIG. 21 is a flowchart showing an example of a process for generating the address translation table of FIG. 20;

FIG. 22 is a flowchart showing an example of a process for generating the address translation table continued from FIG. 21;

FIG. 23 is a flowchart showing a power-on reset process of the memory device according to a third embodiment of the invention;

FIG. 24 is a detailed flowchart of the processes of Steps S1002 and S1003 shown in FIG. 23;

FIG. 25 is a signal timing chart of the memory device in the process of FIG. 24;

FIG. 26 is a block diagram of a memory device according to still another embodiment of the invention; and

FIG. 27 is a flowchart showing an example of a process for generating the address translation table in the memory device of FIG. 26.

### DETAILED DESCRIPTION OF THE PREFERRED EMBODIMENTS

Hereinafter, preferred embodiments of the invention will be described in detail with reference to the accompanying drawings. In the entire drawings for describing the embodiments, the same reference numerals are assigned to the same members and the description thereof will not be repeatedly given unless such description is necessary.

(Embodiment 1)

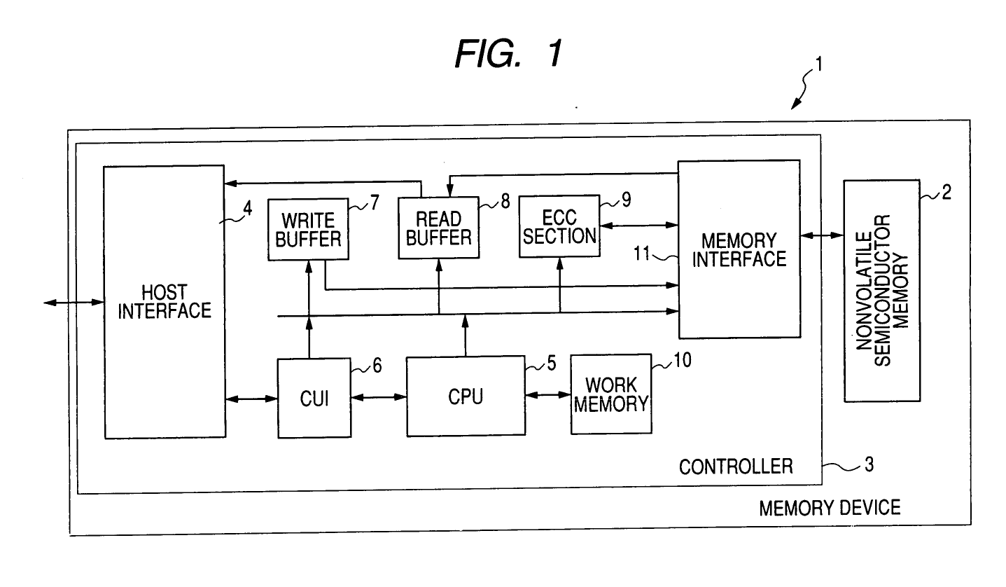

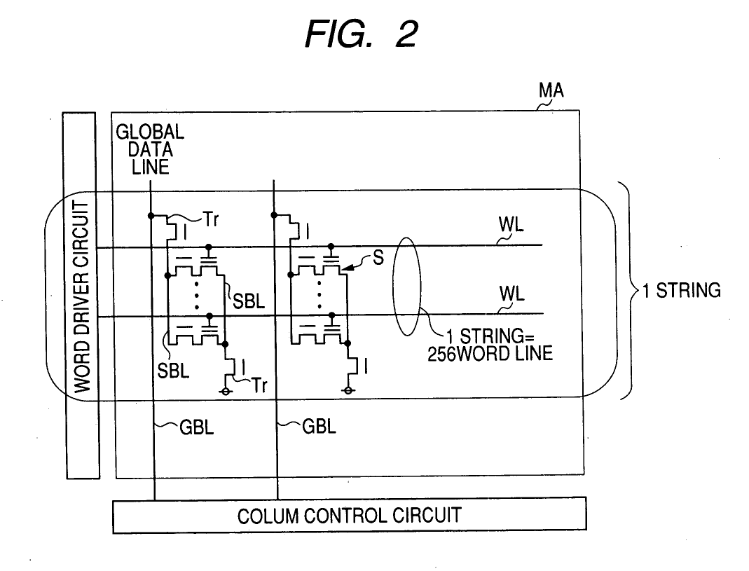

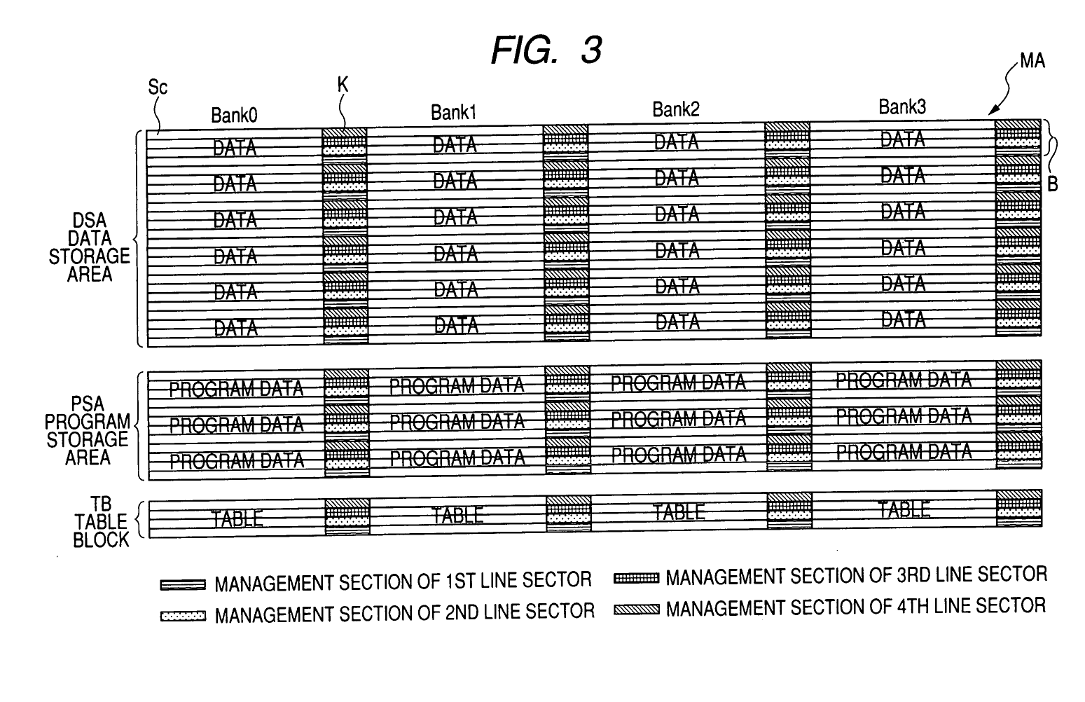

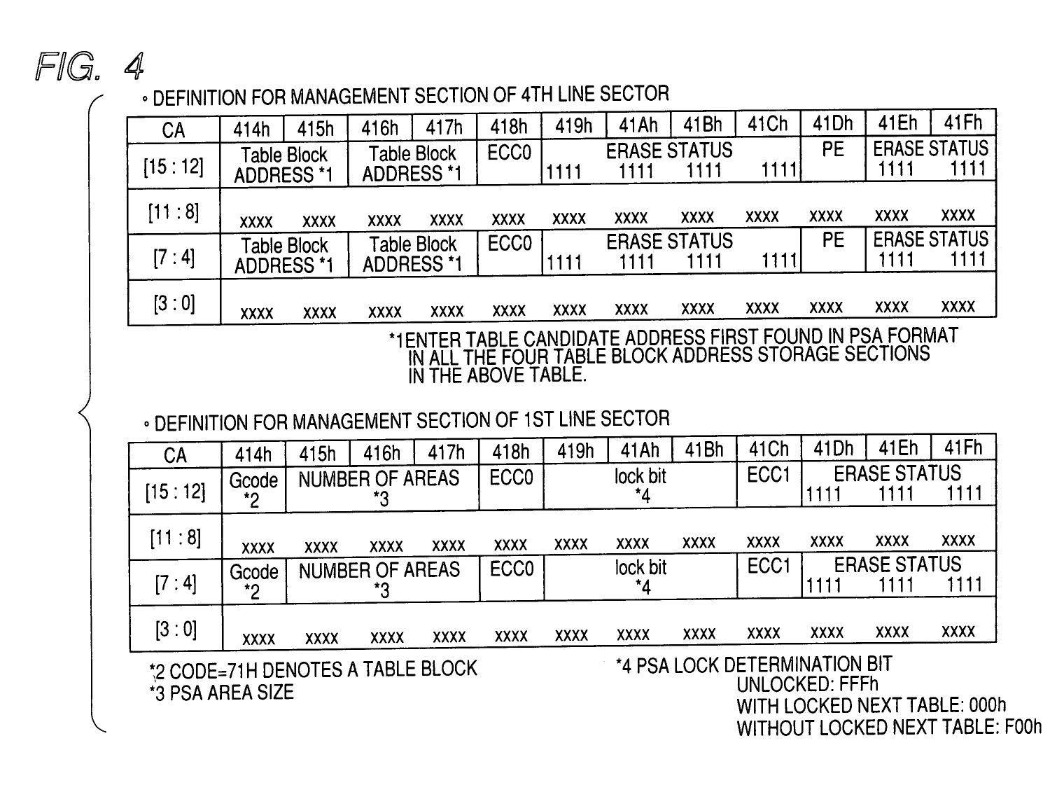

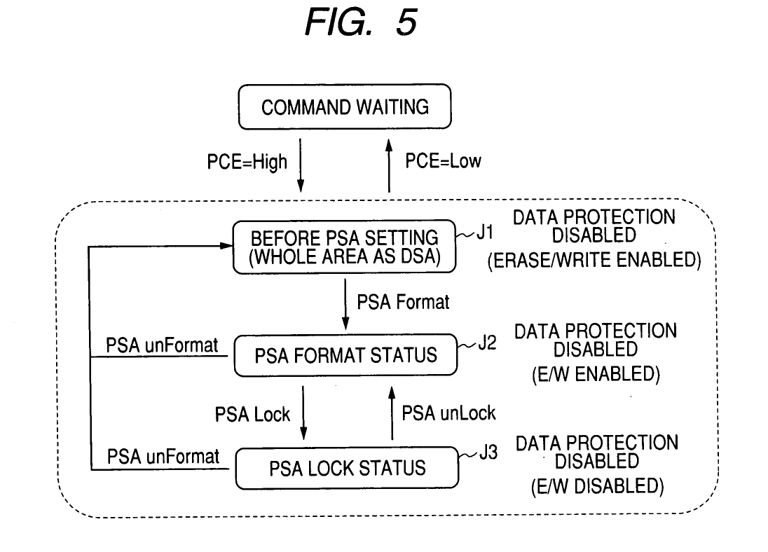

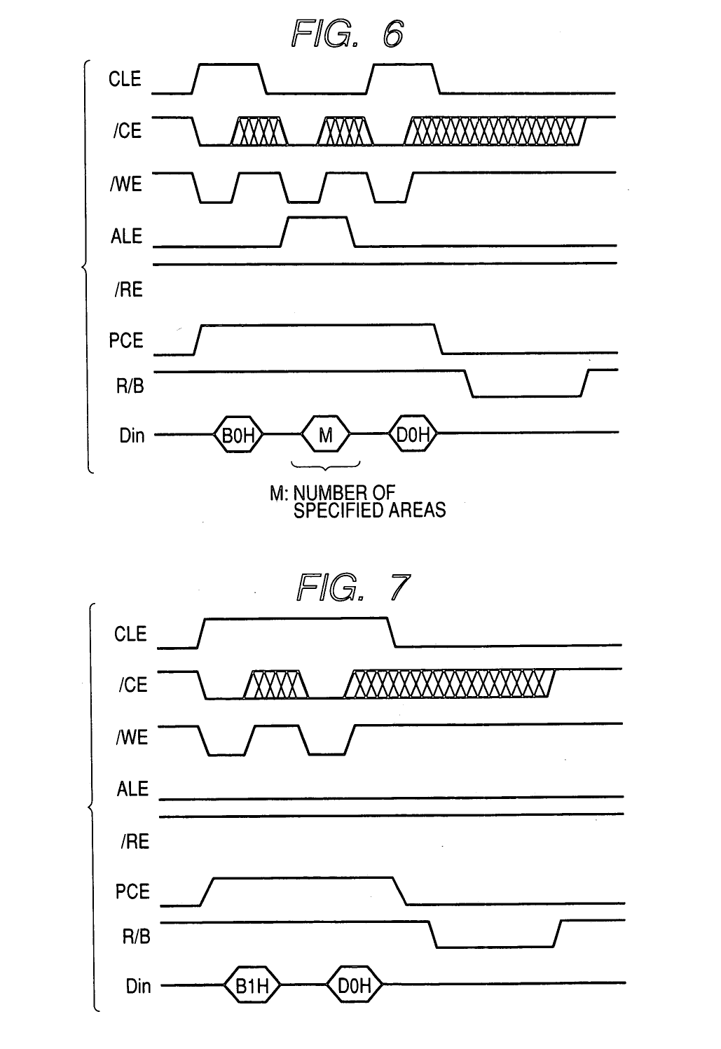

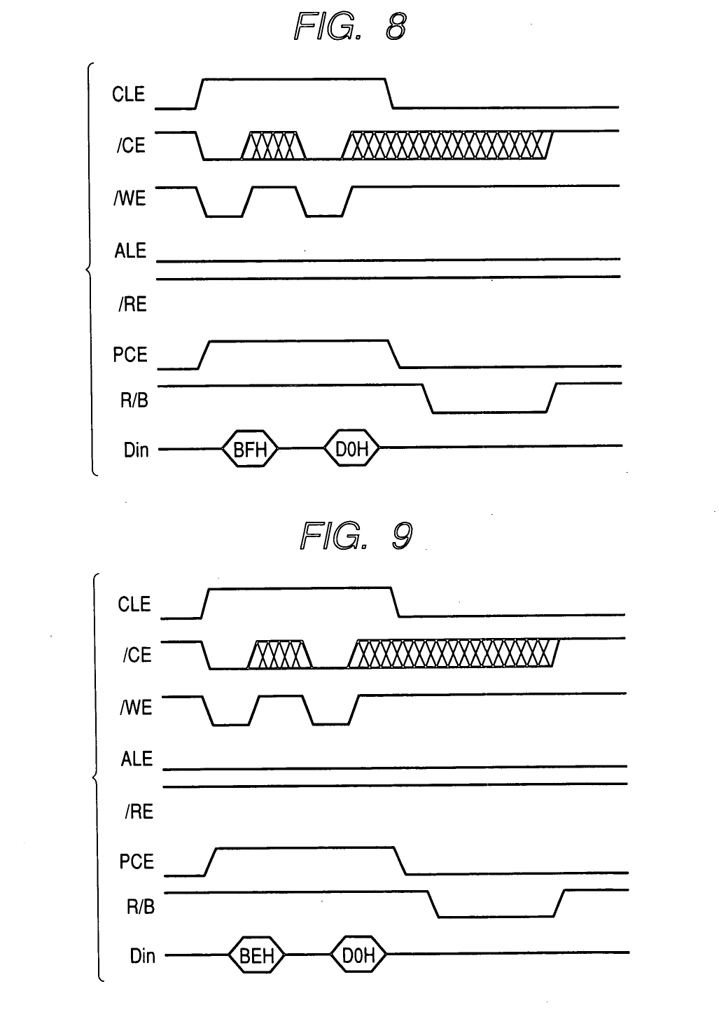

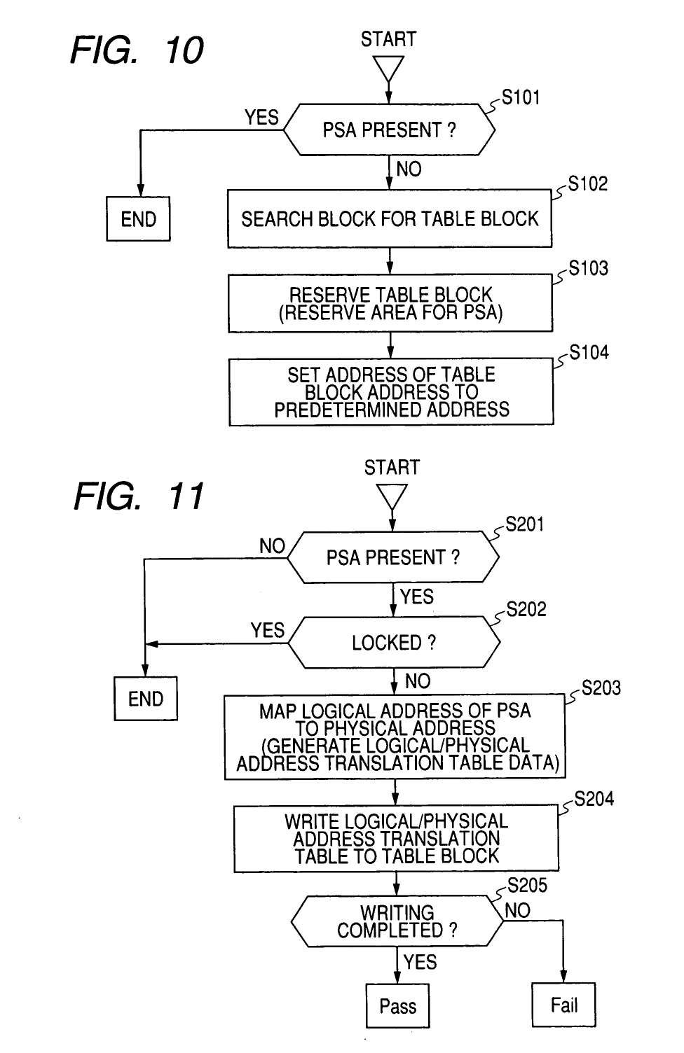

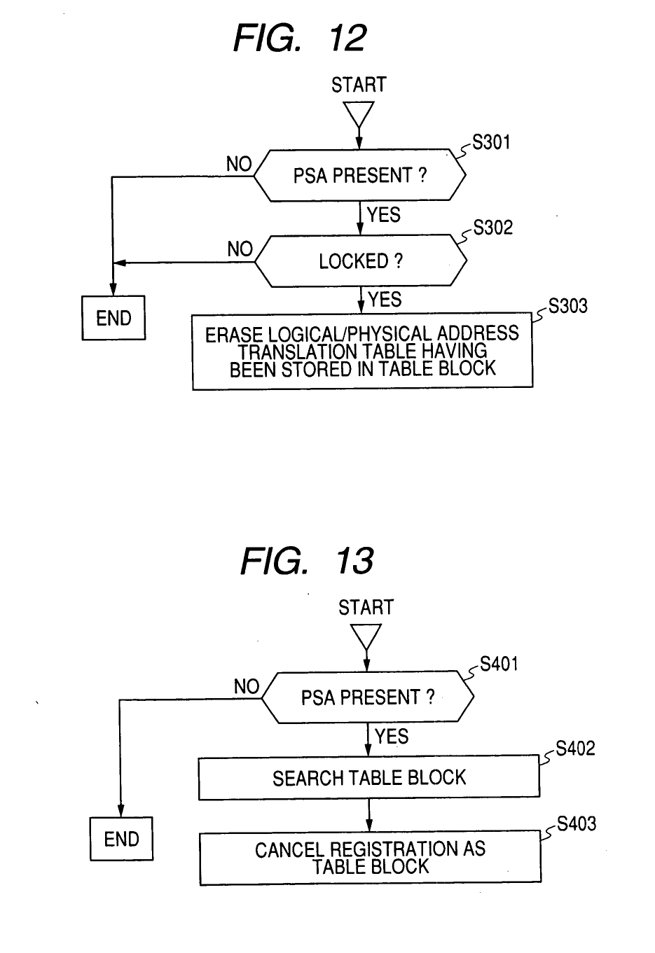

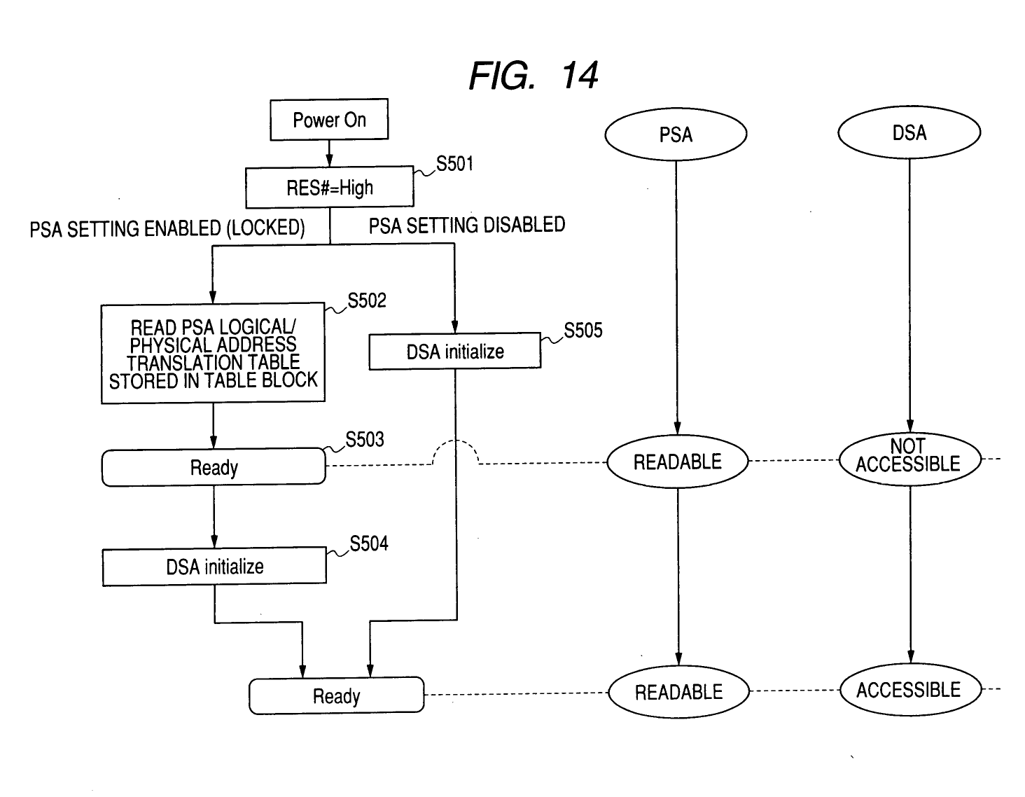

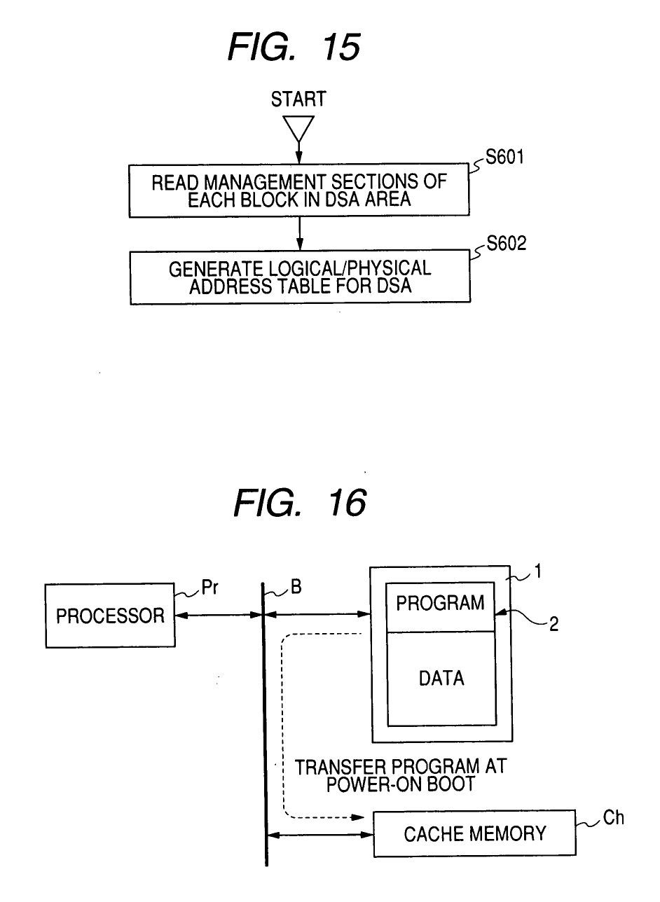

FIG. 1 is a block diagram of a memory device according to Embodiment 1 of the invention. FIG. 2 is a diagram illustrating a memory array configuration example in a nonvolatile semiconductor memory provided in the memory device of FIG. 1. FIG. 3 is a diagram illustrating an example of a memory area configuration in the memory array of FIG. 2. FIG. 4 is a diagram illustrating an example of management information data definitions in management sections provided in the memory array of FIG. 3. FIG. 5 is a diagram illustrating a status transition in the setting of a program storage area to the memory array of FIG. 3. FIG. 6 is a timing chart showing a signal cycle for setting the program storage area to the memory array of FIG. 3. FIG. 7 is a timing chart showing a signal cycle in a PSA lock status after the setting of the program storage area in the memory array of FIG. 3. FIG. 8 is a timing chart showing a signal cycle for performing PSA Unformat of the memory array of FIG. 3. FIG. 9 is a timing chart showing a signal cycle for performing PSA Unlock of the memory array of FIG. 3. FIG. 10 is a flowchart showing an example of a PSA Format process in the memory device of FIG. 1. FIG. 11 is a flowchart showing an example of a PSA Lock process in the memory device of FIG. 1. FIG. 12 is a flowchart showing an example of a PSA Unlock process in the memory device of FIG. 1. FIG. 13 is a flowchart showing an example of a PSA Unformat process in the memory device 1 of FIG. 1. FIG. 14 is a flowchart showing an example of a power-on reset process and a status of the program storage area, in the setting of the program storage area in the memory device of FIG. 1. FIG. 15 is a flowchart showing an example of an initialization process of the data storage area in the memory device of FIG. 1. FIG. 16 is a block diagram showing an example of an electronic system configured by using the memory device of FIG. 1.

In Embodiment 1, a memory device (semiconductor integrated circuit device) 1 includes, as shown in FIG. 1, a nonvolatile semiconductor memory 2 capable of electrically rewriting and erasing data, which is exemplified by the flash memory, and a controller 3.

The controller 3 includes a host interface 4, a CPU 5, a CUI (Command User Interface) 6, a write buffer 7, a read buffer 8, an ECC section 9, a work memory 10, a memory interface 11 and the like.

The controller 3 takes control of the nonvolatile semiconductor memory 2, reading the programs and data stored in the nonvolatile semiconductor memory 2 to output to a host device, or providing instruction of the writing operation of the programs and data input from the host device.

The host interface 4 is an interface between the host device and the CPU 5. The CPU 5 provides all the controls in the controller 3. The CUI 6 interprets the command from the host and activates the CPU 5.

The write buffer 7 temporarily stores data read from the host. The read buffer 8 temporarily stores data read from the nonvolatile semiconductor memory 2.

The ECC section 9 performs the generation of an ECC (Error Check and Correction) code, as well as the ECC error check and correction of the data written to/read from the nonvolatile semiconductor memory 2.

The work memory 10 includes a semiconductor memory such as, for example, a RAM, which is used as a memory of the work area of the CPU 5. The memory interface 11 is an interface between the CPU 5 and the nonvolatile semiconductor memory 2.

FIG. 2 is a diagram illustrating an example of a memory array (memory area) MA in the nonvolatile semiconductor memory 2.

As shown in the figure, the memory array MA has an array configuration with a plurality of sub bit lines SBL connected to a global bit line GBL via a selection transistor Tr, in which the sub bit lines SBL are connected to nonvolatile memory cells S, respectively.

The sub bit lines SBL are connected to the nonvolatile memory cells S of 256 word lines WL, the unit of which is defined as one string.

FIG. 3 is a diagram illustrating an example of a memory area configuration in the memory array MA of the nonvolatile semiconductor memory 2.

The memory array MA has, for example, a 4-bank configuration that divides the memory array into 4 banks 0 to 3. Each of the banks 0 to 3 includes a data storage area DSA, a program storage area PSA and a table block TB.

The data storage area DSA is an area in which the data is stored. The program storage area PSA is an area in which the programs are stored. This program stored in the program storage area PSA is not only for the CPU in the controller but also for the CPU in the host device. And the data stored in the data storage area DAS is not only for the CPU in the controller but also the CPU in the host device, too. The table block TB is an area in which the address translation table for the program storage area PSA is stored.

In the data storage area DSA, program storage area PSA and table block TB, a management section (a portion indicated by hatching in FIG. 3) K is provided for each sector Sc. Herein, the sector Sc is the minimum unit of data storage. One block (the minimum unit for erasing) B is formed by 16 sectors (4 bank rows×4 lines).

In the management section K there is stored management information for each block. The same management information is stored for the sectors in the same line, although belonging to the different banks. However, the content of the management information varies in the different lines.

The area of the program storage area PSA is randomly set. The table block TB for storing the translation table data of logical address/physical address is prepared in the setting of the program storage area PSA. Herein, the address of the table block TB may be previously specified or may be an address that can be easily searched.

FIG. 4 is a diagram illustrating an example of management information data definitions in the management sections K.

In FIG. 4, there are only shown the management sections involved in the processing of the program storage area PSA, in which the upper part represents the management section of the fourth line sector and the lower part represents the management sector of the first line sector, respectively.

As shown in the figure, the management section of the fourth line sector includes areas for storing the address of the table block. However, the address of the table block is actually written only to a good block of the least significant address.

The areas in the other blocks to which the table block address of the management section of the fourth line sector is written, are in the erase status (‘FFh’). In other words, a way to search the block used as the table block is to read the management section of the fourth line sector in the good block of the least significant address.

The block selected as the table block is then recognized as a block for the table by writing the code ‘71h’ to the management section of the first line sector. In the management section of the first line sector, there are also stored the area size of the program storage area PSA, the lock determination bit of the program storage area PSA and the like.

FIG. 5 is a diagram illustrating a status transition in the setting of the program storage area PSA to the memory array MA of the nonvolatile semiconductor memory 2.

The program storage area PSA is set, for example, by an input of a PSA set command for setting the area of the program storage area PSA. The nonvolatile semiconductor memory 2 has a control pin to which a PCE (Protect Control Enable) signal is input.

For example, the PSA set command is received when the PCE signal of high level is input to the control pin, while the PSA set command is not received when the PCE signal is low level.

In the memory array MA, as shown in the figure, there exist three statuses: a status before PSA setting (status J1), a PSA Format status (status J2), and a PSA Lock status (status J3).

The status before PSA setting (status J1) is a status in which the area setting of the program storage area PSA is not done by the PSA set command, and in which erasing/writing is enabled (the whole area is equivalent to the DSA area). The PSA format status (status J2) is a status in which the area setting of the program storage area PSA is done by the PSA set command. Also in this status J2, the data protection is disabled and erasing/writing is enabled (the PSA setting is done but the whole area acts as the DSA area).

The PSA Lock status (status J3) is a status in which the program storage area PSA which has been set is locked (PSA Lock) with the data protection enabled. Thus erasing/writing is disabled in the program storage area PSA (the PSA set area acts as the PSA area).

The status J3 can be switched to the status J2 by releasing the lock (PSA Unlock). The statuses J2, J3 can be switched to the status J1 by releasing the setting of the program storage area PSA (PSA Unformat).

FIG. 6 is a timing chart showing a signal cycle for setting the program storage area PSA.

In FIG. 6, from top to bottom there are shown: command latch enable CLE, chip enable /CE, write enable /WE, address latch enable ALE, read enable /RE, protect control enable signal PCE, ready busy R/B, and data Din which is the command to be input. Incidentally, of these control signals, those having a slash (/) represent inversion signals.

In this case, after the PCE signal becomes high level, the commands ‘B0H’, ‘M’, ‘D0H’ are sequentially input as the data Din for setting the area of the program storage area PSA.

The command ‘M’ is to set the specified area. The area setting of the program storage area PSA is done, for example, in units of strings. Thus, the number of strings is input. After the command for the area setting of the program storage area PSA is input, the ready busy R/B is “busy” until the area setting of the program storage area PSA is completed.

FIG. 7 is a timing chart showing a signal cycle in a PSA Lock status after the area setting of the program storage area PSA. Incidentally, the signals shown from top to bottom are the same in FIG. 7 and also in FIGS. 8, 9 described below.

In FIG. 7, after the PCE signal becomes high level, the commands ‘B1H’, ‘D0H’ are sequentially input as the data Din to make the lock that enables the data protection of the program storage area PSA which has been set.

Also herein, after the command for setting the PSA Lock status is input, the ready busy R/B is “busy” until the lock setting of the program storage area PSA is completed.

FIG. 8 is a timing chart showing a signal cycle for performing PSA Unformat.

The commands to perform PSA Unformat are ‘BFH’, ‘D0H’. Similarly to FIGS. 6 and 7, after the commands for performing PSA Unformat are input, the ready busy R/B is “busy” until PSA Unformat is completed.

FIG. 9 is a timing chart showing a signal cycle for performing PSA Unlock.

The commands to perform PSA Unlock are ‘BEH’,‘D0H’ Similarly to FIGS. 6 to 8, after the commands for performing PSA Unlock are input, the ready busy R/B is “busy” until PSA Unlock is completed.

FIG. 10 is a flowchart showing an example of a PSA Format process in the memory device 1.

First, in the memory array, it is determined whether the area of the program storage area PSA is set (Step S101) In this process of Step S101, when the area of the program storage area PSA is set (PSA is formatted) the PSA format process ends here.

On the other hand, when PSA is not formatted in the process of Step S101, the block to be used as a table block is searched (Step S102), and the code indicating as the table block and its area size are written to the management section (Step S103).

Next, the address information of the searched table block is written to a predetermined position, such as for example, the management section of the good block of the least significant address (Step S104).

FIG. 11 is a flowchart showing an example of a PSA Lock process in the memory device 1.

First, it is determined whether the program storage area PSA is formatted or unformatted (Step S201), and when unformatted, the process ends here. When determined as formatted in the process of Step S201, it is then determined whether the program storage area PSA is locked or unlocked (Step S202). When it is locked, the process ends here.

Next, the logical address of the program storage area PSA and the physical address are mapped to generate an address translation table that controls translation from the logical address to the physical address of the nonvolatile semiconductor memory 2 (Step S203).

Then, the generated address translation table is written to the table block (Step S204). At this time, the PSA lock determination bit is also written to the management section of the table block.

Subsequently, it is determined whether the writing is completed (Step S205). When it is completed, the process ends. When the writing is failed, a new table block is provided to write the table data.

FIG. 12 is a flowchart showing an example of a PSA Unlock process in the memory device 1.

First, it is determined whether the program storage area PSA is formatted or unformatted (Step S301). When the program storage area PSA is formatted, it is then determined whether the program storage area PSA is locked or unlocked (Step S302).

When the program storage area PSA is determined to be unformatted in the process of Step S301 and also determined to be unlocked in the process of Step S302, the process ends here.

On the other hand, the program storage area PSA is locked in the process of Step S302, the data stored in the table block is erased (Step S303). In this case, the code indicating the table block and the data of the area size of the program storage area PSA are written in the management section, and the lock determination bit is erased therefrom. In this manner the program storage area PSA is returned to the PSA Format status.

FIG. 13 is a flowchart showing an example of a PSA Unformat process in the memory device 1.

First, it is determined whether the program storage area PSA is formatted or unformatted (Step S401). When the program storage area PSA is unformatted, the process ends here.

When the program storage area PSA is formatted, the table block is searched (Step S402), and the registration of the searched table block is canceled (Step S403).

FIG. 14 is flowchart showing an example of a power-on reset (initialization operation) process and a status of the program storage area PSA, in the area setting of the program storage area PSA of the memory device 1.

In FIG. 14, the left side shows the flow of the power-on reset process in the area setting of the program storage area PSA, and the right side shows the status in the area of the program storage area PSA in the area setting of the program storage area PSA.

First, a reset signal is input by power-on (Step S501). When the PSA lock is set, the address translation table for the table block is read (Step S502), and then the status is ready (Step S503).

After the process of Step S503, the program storage area PSA becomes readable. On the other hand, the data storage area DSA is in the inaccessible status.

Then, the address translation table for the data storage area DSA is generated by performing initialization operation of the data storage area DSA (Step S504).

Thus, the nonvolatile semiconductor memory 2 is in the ready status, in which the program storage area PSA is readable and the data storage area DSA is accessible as well.

On the other hand, when the lock of the program storage area PSA is not set (PSA Format or PSA Unformat) the initialization operation is performed for the data storage area DSA (Step S505). The management sections of all the sectors are read to generate the address translation table. Upon completion of Step S505, the nonvolatile semiconductor memory 2 is in the ready status, so that the data storage area DSA becomes accessible.

FIG. 15 is a flowchart showing an example of an initialization process of the data storage area DSA.

First, all the management sections in the unlocked program storage area PSA and in the data storage area DSA are read (Step S601). Subsequently, the address translation table for the data storage area DSA (Step S602) is generated. The generated address translation table is stored to the work memory 10.

FIG. 16 is a block diagram showing an example of an electronic system configured by using the memory device 1.

As shown in the figure, the memory device 1 is interconnected via a bus B, for example, with a processor Pr which is the host device and a cache memory Ch. In the nonvolatile semiconductor memory 2 of the memory device 1, for example, the programs and data for the host is stored. The programs and data for the host are read from the nonvolatile semiconductor memory 2 at power-on, and transferred to the cache memory Ch which includes, for example, SRAM (Static Random Access Memory)/SDRAM (Synchronous Dynamic RAM or other peripheral devices.

Thus, the program storage area PSA for storing the programs may only become accessible at power-on, so that the initialization of the data storage area DSA can be performed in the background concurrently with the initialization of the processor Pr of the electronic system or other events.

As described above, according to Embodiment 1, it is possible to substantially reduce the time of the power-on reset process in the memory device 1.

(Embodiment 2)

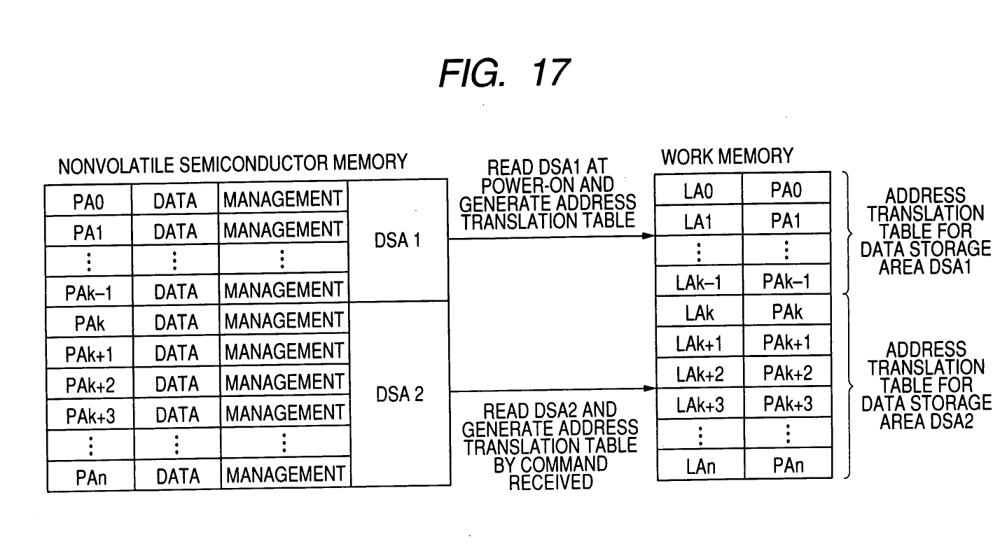

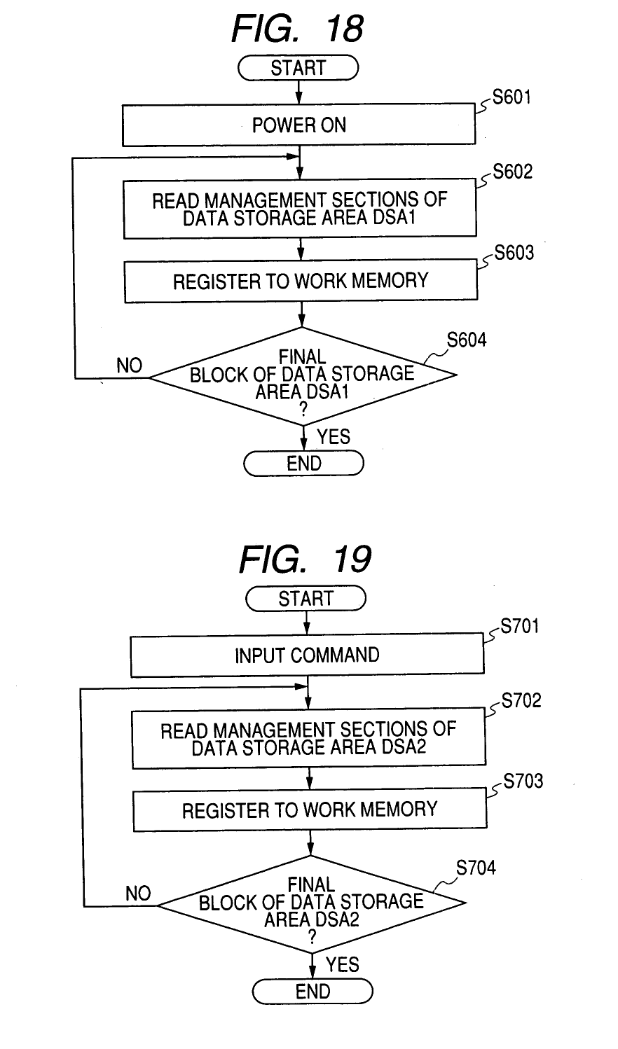

FIG. 17 is a diagram illustrating an example of an address translation table generated at power-on reset of the memory device according to Embodiment 2 of the invention. FIG. 18 is a flowchart showing an example of a process for generating the address translation table at power-on of FIG. 17. FIG. 19 is a flowchart showing an example of a process for generating the address translation table after the generation of the address translation table of FIG. 18.

The memory device 1 according to Embodiment 2 is the same as in FIG. 1 of Embodiment 1, which includes the nonvolatile semiconductor memory 2 and the controller 3. The controller 3 includes the host interface 4, CPU 5, CUI 6, write buffer 7, read buffer 8, ECC section 9, work memory 10, and the memory interface 11.

FIG. 17 shows an example of generating an address translation table at power-on of the memory device 1.

In this case, as shown in the figure, the data storage area DSA of the nonvolatile semiconductor memory 2 is randomly divided into two data storage areas DSA1, DSA2. The address translation table for the data storage area DSA1 is only generated in the power-on reset process of the memory device 1. The area setting of the data storage areas DSA1, DSA2 is done, for example, by an input of a set command from the host device.

Then, the generation of the address translation table for the data storage area DSA1 is completed and the command for generating the address translation table for the data storage area DSA2 is output from the host device. In accordance with this command, the address translation table for the data storage area DSA2 is generated.

Next, an example of generating an address translation table in the data storage area DSA1 will be described with reference to the flowchart of FIG. 18. Incidentally, the processing shown in FIG. 18 is done in the process of Step S504 of FIG. 14.

First, a reset signal is input by power-on (Step S601). Upon completion of the process of Step S503 in FIG. 14, the management sections of the data storage area DSA1 are read (Step S602), and the address translation table for the first block in the data storage area DSA1 is generated.

The generated address translation table is stored to the work memory 10 (Step S603). Then, the processes of Steps S602, S603 are repeated until the address translation table for the final block in the data storage area DSA1 is generated (Step S604). After the address translation table for all the blocks in the data storage area DSA1 is generated, the generation process of the address translation table in the data storage area DSA1 is completed.

Further, an example of generating an address translation table in the data storage area DSA2 will be described with reference to the flowchart of FIG. 19.

Upon completion of the generation process of the address translation table in the data storage area DSA1 as shown in FIG. 18, the command for generating the address translation table for the data storage area DSA2 is input from the host device (Step S701). In accordance with this command, the management sections of the data storage area DSA2 in the nonvolatile semiconductor memory 2 are read (Step S702), and the address translation table for the first block in the data storage area DSA2 is generated. Then, the generated address translation table is stored to the work memory 10 (Step S703).

The processes of Steps S702, S703 are repeated until the address translation table for the final block of the data storage area DSA2 is generated (Step S704). After the address translation table for all the blocks in the data storage area DSA2 is generated, the generation process of the address translation table in the data storage area DSA2 is completed.

As described above, in Embodiment 2, it is also possible to substantially reduce the time of the power-on reset process in the memory device 1.

Further, in Embodiment 2, it has been assumed that the memory area of the nonvolatile semiconductor memory 2 is randomly divided into the two data storage areas DSA1, DSA2. For example, when the memory device 1 is provided with a plurality of nonvolatile semiconductor memories, there may be previously set a nonvolatile semiconductor memory in which the address translation table is generated at power-on and a nonvolatile semiconductor memory in which the address translation table is generated after the command input from the host device.

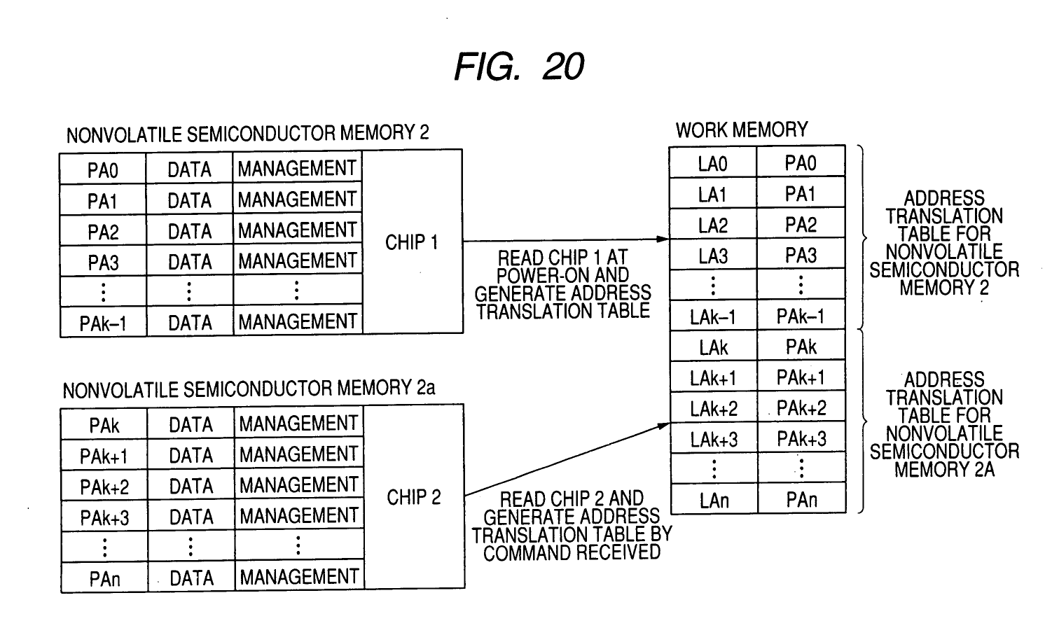

FIG. 20 shows an example of an address translation table generated at power-on, for example, in the memory device provided with two nonvolatile semiconductor memories.

In this case, as shown in the figure, there is generated, in the power-on process, the address translation table for the data storage area DSA in one nonvolatile semiconductor memory 2 of the previously set nonvolatile semiconductor memories. Subsequently, the command for generating the address translation table is output from the host device, and then the address translation table for the data storage area DSA in the other nonvolatile semiconductor memory 2a is generated.

In this manner, the address translation table for the nonvolatile semiconductor memories 2, 2a is generated in the work memory 10, as shown in the right side of FIG. 20.

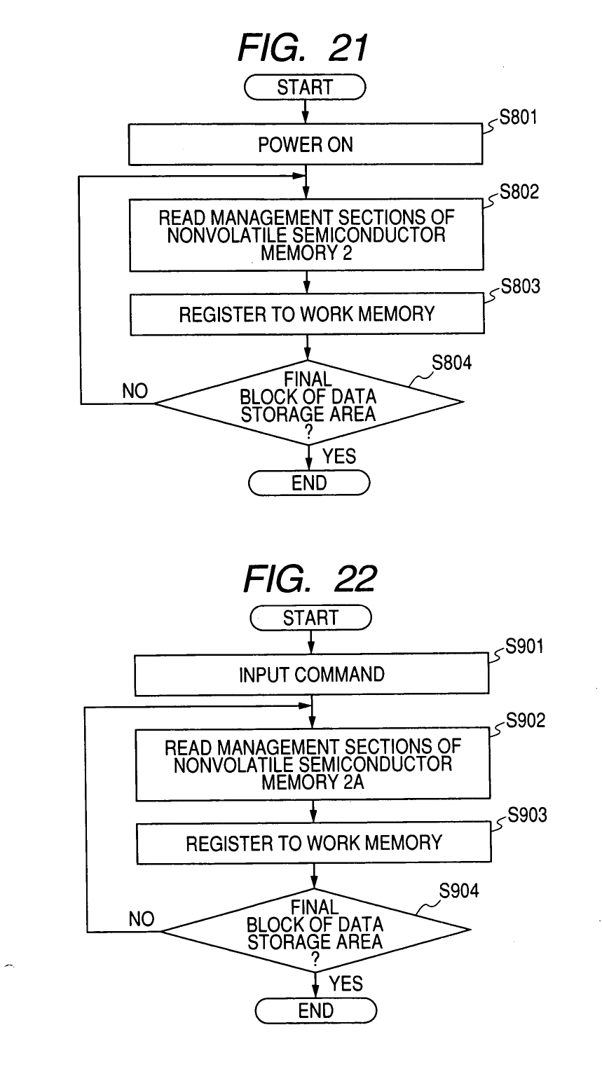

FIG. 21 is a flowchart showing an example of a process for generating the address translation table at power-on of the memory device provided with the two nonvolatile semiconductor memories 2, 2a.

First, a reset signal is input by power-on (Step S801). Upon completion of the process of Step S503 in FIG. 14, the management sections in the data storage area DSA of the nonvolatile semiconductor memory 2 are read (Step S802), and the address translation table for the first block in the nonvolatile semiconductor memory 2 is generated.

The generated address translation table is stored to the work memory 10 (Step S803). Then, the processes of Steps S802, S803 are repeated until the address translation table for all the blocks in the nonvolatile semiconductor memory 2 is generated (Step S804).

After the address translation table for all the blocks in the nonvolatile semiconductor memory 2 is generated, the generation process of the address translation table is completed.

An example of generating the address translation table in the other nonvolatile semiconductor memory 2a will be described with reference to the flowchart of FIG. 22.

Upon completion of the generation process of the address translation table shown in FIG. 21, the command for generating the address translation table for the nonvolatile semiconductor memory 2a is input from the host device (Step S901). In accordance with this command, the management sections of the data storage area DSA in the nonvolatile semiconductor memory 2a are read (Step S902), and the address translation table for the first block in the nonvolatile semiconductor memory 2a is generated. Then, the generated address translation table is stored to the work memory 10 (Step S903).

The processes of Steps S902, S903 are repeated until the address translation table for the final block in the other nonvolatile semiconductor memory is generated (Step S904). After the address translation table for all the blocks in the other nonvolatile semiconductor memory is generated, the generation process of the address translation table is completed.

As described above, even with the memory device provided with a plurality of nonvolatile semiconductor memories, it is still possible to substantially reduce the time of the power-on reset process in the memory device.

(Embodiment 3)

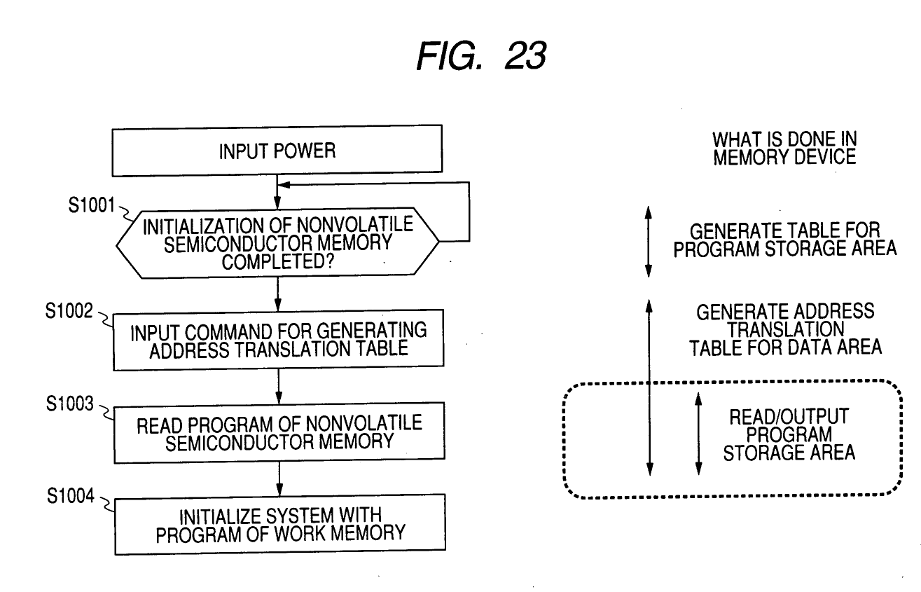

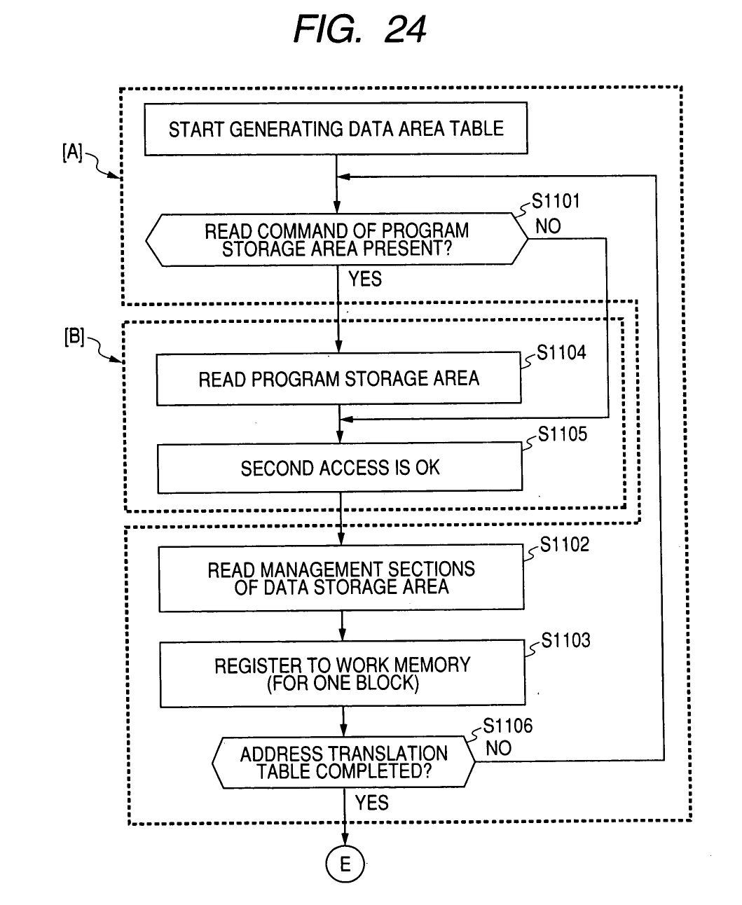

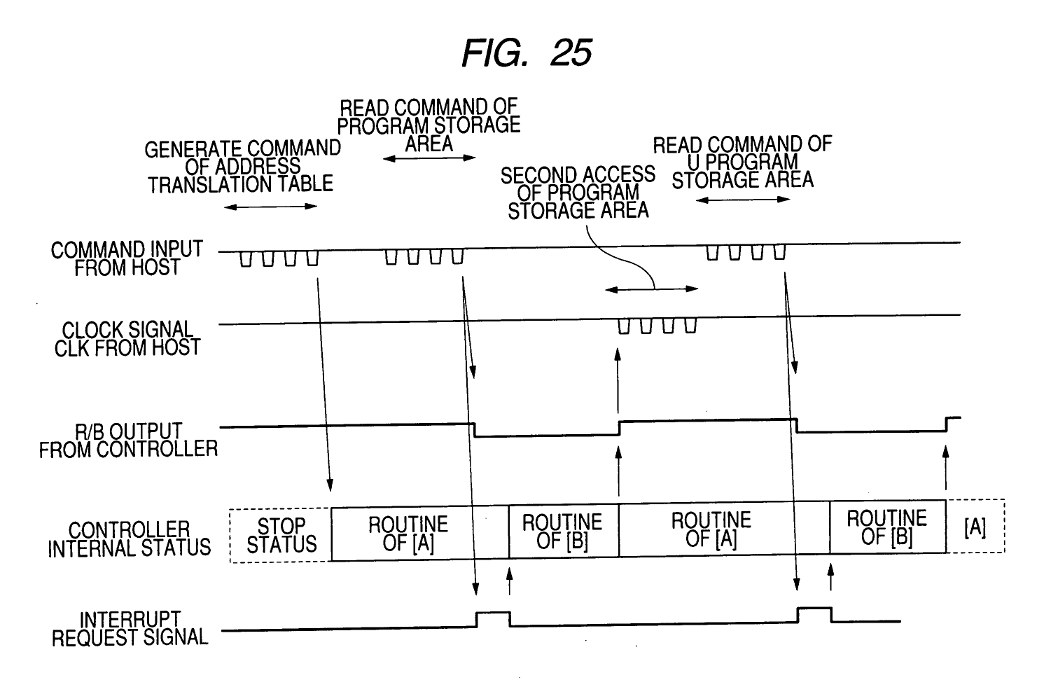

FIG. 23 is a flowchart showing a power-on reset process of a memory device according to Embodiment 3 of the invention. FIG. 24 is a detailed flowchart of the processes of Steps S1002, S1002 shown in FIG. 23. FIG. 25 is a signal timing chart of the memory device in the process of FIG. 24.

The memory device 1 according to Embodiment 3 is also the same as in FIG. 1 of Embodiment 1, which includes the nonvolatile semiconductor memory 2 and the controller 3. The controller 3 includes the host interface 4, CPU 5, CUI 6, writhe buffer 7, read buffer 8, ECC section 9 work memory 10, and the memory interface 11.

The controller 3 according to Embodiment 3 has a function for receiving the read command of the program storage area PSA during the generation of the address translation table in the data storage area DSA.

Next, the power-on reset process by the memory device 1 will be described with reference to the flowchart of FIG. 23.

First the power is input, and then the initialization of the nonvolatile semiconductor memory 2 is completed (Step S1001). In this process of Step S1001, as shown in the upper right side of FIG. 23, the address translation table for the program storage area PSA is generated.

Subsequently, the command for generating the address translation table for the data storage area DSA is input from the host device (Step S1002). The program for the program storage area PSA is expanded in the work memory 10 (Step S1003).

In the processes of Steps S1002 and S1003, as shown in the upper right side of FIG. 23, the address translation table for the data storage area DSA is generated. In addition, the program of the program storage area PSA is read in the process of Step S1003. The process of Step S1003 is performed so that the generation of the address translation table of the data storage area DSA is done in the background concurrently with the reading of the program from the program storage area PSA, as shown in the region enclosed by the dashed line.

The initialization operation of the memory device 1 is performed by the program expanded in the work memory 10 (Step S1004), and then the initialization is completed.

Next, the processes of Steps S1002, S1003 of FIG. 23 will be described in detail with reference to the flowchart of FIG. 24 and to the timing chart of FIG. 25.

In FIG. 24, there are shown from top to bottom the timings of the command output from the host device, the clock signal CLK for data reading output from the host device, the ready busy R/B output from the controller 3, the internal operation status of the controller 3, and the interrupt request signal, respectively.

The memory device 1 first receives the command for generating the address translation table in the data storage area DSA from the host device. Then the memory device 1 starts the routine process shown in (A) of FIG. 24, and determines whether the read command of the program storage area has been issued (Step S1101).

In the process of Step S1001, when the read command of the program storage area has not been issued, the controller 3 sets the ready busy R/B to ‘Hi’ to the ready status. Then, the controller 3 reads the data of the management sections in the data storage area DSA (Step S1102), generates the address translation table for one block, and stores the generated table to the work memory 10 (Step S1103).

Next, returning to Step S1101, the memory device 1 determines whether the read command of the program storage area has been issued during the processes of Steps S1102, S1103.

When the read command of the program storage area has been issued from the host device, the flag of the interrupt request signal is set to ‘Hi’ within the controller 3. At this time, the controller 3 causes the routine process shown in (B) of FIG. 24 to be interrupted by setting the ready busy R/B to the busy status. Then, the controller 3 resets the flag of the interrupt request signal (‘Lo’).

Next, the controller 3 reads the data of the program storage area PSA (Step S1104). When the error correction of the read data is completed and a second access becomes available (Step S1105), the controller 3 sets again the ready busy R/B to the ready status so that the command for the second access from the host device can be received. Upon completion of the routine process of (B), the controller 3 performs the processes of Steps S1102, S1103. The routine process of (A) is repeated until the address translation table in the data storage area DSA is completed (Step S1106).

At this time, when the command for the second access is issued from the host device, the controller 3 transfers the read data to the host device based on the clock signal CLK for data reading from the host device, while performing the routine process of (A) to generate the address translation table.

The data reading operation of the program storage area PSA includes a first access and a second access, similarly to the data reading from the data storage area DSA. In the first access, the data read from the nonvolatile semiconductor memory 2 by the controller 3 is transferred to the read buffer 8.

In the second access, the data stored in the read buffer 8 is read out to the host by the clock signal CLK. During the second access, the controller 3 is in a free status as the reading operation, which makes it available to perform other internal operations.

Thus, it is possible to continuously generate the address translation table using the free status of the second access.

Incidentally, in this case, a status read command is provided to know the completion of the generation of address translation table in the data storage area DSA. A given number of data readings are completed in the program storage area PSA, and when the host device wants to access the data storage area DSA, the host device first outputs the status read command to confirm that the generation of address translation table in the data storage area DSA has been completed before accessing it.

As described above, in Embodiment 3, it is possible to read the data of the program storage area PSA during the generation of the address translation table in the data storage area DSA.

Further, it is possible to generate the address translation table in the data storage area DSA while reading the data of the program storage area PSA, allowing the access to the data storage area DSA at a shorter time.

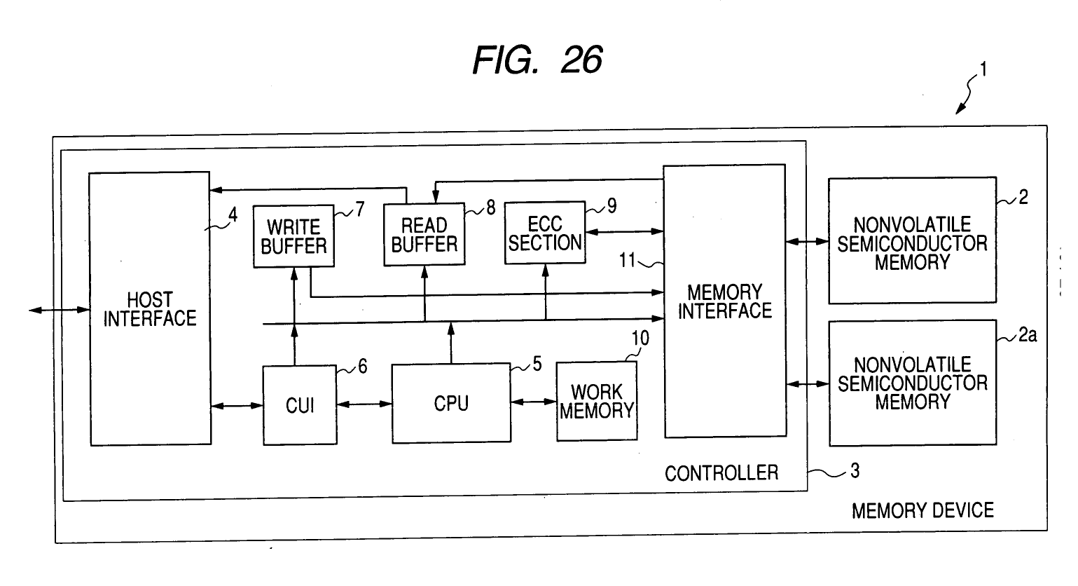

In the embodiment there has been described the case in which the memory area of one nonvolatile semiconductor memory is divided into the program storage area PSA and the data storage area DSA. However, for example as shown in FIG. 26, the memory device 1 may be provided with two nonvolatile memories 2, 2a, in which the memory area of one nonvolatile semiconductor memory 2 is set as the program storage area PSA and the memory area of the other nonvolatile semiconductor memory 2a is set as the data storage area DSA.

In this case, the nonvolatile semiconductor memory 2a is newly connected to the memory interface 11, and the other connection configuration of the memory device 1 shown in FIG. 26 is the same as that of the memory device 1 shown in FIG. 1.

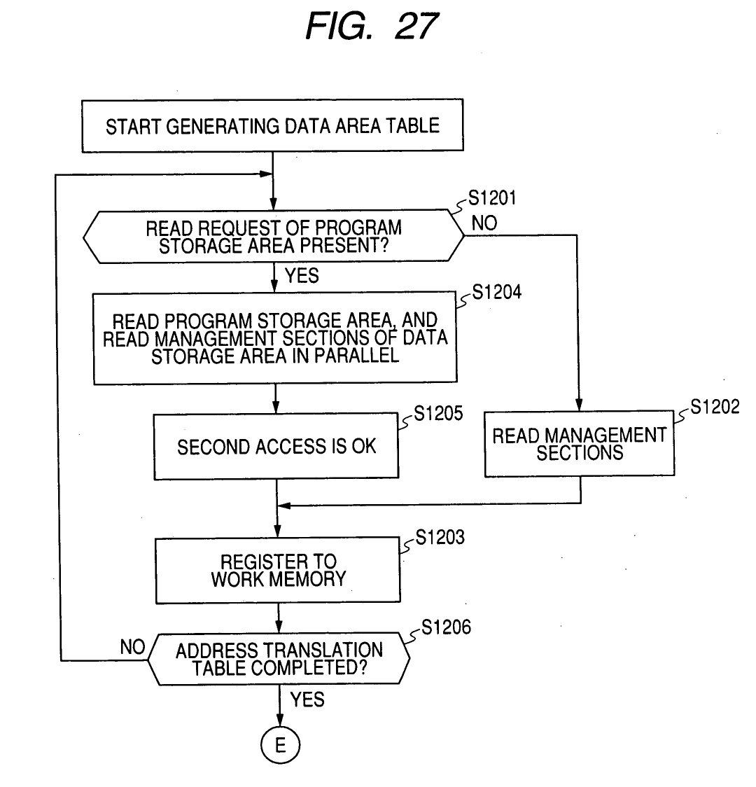

FIG. 27 is a flowchart showing an example of a process for generating the address translation table of the data storage area DSA in the memory device 1 shown in FIG. 26.

First, the controller 3 receives the command for generating the address translation table in the data storage area DSA from the host device, and determines whether the read command of the program storage area has been issued (Step S1201).

In the process of Step S1201, when the read command of the program storage area has not been issued, the controller 3 reads the management sections of the nonvolatile semiconductor memory 2a (Step S1202), and registers the generated address translation table to the work memory 10 (Step S1203).

On the other hand, when the read command of the program storage area has been issued in the process of Step S1201, the controller 3 performs the process of reading the management section of the nonvolatile semiconductor memory 2a and generating the address translation table in parallel with the data reading from the program storage area PSA (Step S1204).

Next, when the error correction of the read data is completed and the second access becomes available (Step S1205), the process of Step S1203 is performed. The processes of Steps S1201 to S1205 are repeated until the address translation table in the data storage area DSA of the nonvolatile semiconductor memory 2a is completed (Step S1206).

In this manner, the reading from the program storage area PSA of the nonvolatile semiconductor memory 2 and the reading of the management section of the data storage area DSA in the nonvolatile semiconductor memory 2a can be performed in parallel, so that the total time for the first access of the nonvolatile semiconductor memories 2, 2a can be reduced.

Although in FIG. 26 there has been described that the nonvolatile semiconductor memories 2, 2a are controlled by the one CPU 5, the nonvolatile semiconductor memories may be individually controlled by different CPUs.

In this manner, it is possible to process the reading of the program storage area PSA in parallel with the generation of the address translation table in the data storage area DSA, which have been performed in a time-sharing manner. Thus, the operation time can be further reduced.

The invention made by the inventors is capable of increasing the speed of the initializing operation of the memory device, and is capable of reducing the amount of the table block of the memory device.

When the usage of this memory device of the invention is the boot device for the host device, it is possible that the boot process of the host device is made faster. When the host device issues the address for reading out the boot program thereof from the memory device, the memory device already has the address translation table which stores the address of the boot program. Therefore, the memory device can promptly provide the boot program to the host device by reading out the boot program from the program storage area PSA thereof.

The invention made by the inventors has been described in detail based on the embodiments. However, it goes without saying that the invention is not limited to the above described embodiments and may be modified in various ways without departing from the spirit and scope of the invention.

The present invention is applicable to the reduction technology of initialization operation time in nonvolatile semiconductor memories.

1. A semiconductor integrated circuit device comprising:
a nonvolatile semiconductor memory having a plurality of nonvolatile memory cells and capable of storing given information; and
a controller for providing operation instructions for said nonvolatile semiconductor memory based on commands issued from the outside,
wherein a memory area of said nonvolatile semiconductor memory includes:
an area set to a first status in which data is not allowed to be updated;
an area set to a second status in which data is allowed to be updated; and
a table block for storing an address translation table in which a logical address supplied from the outside is mapped to each physical address of said area set to said first status, and
wherein said controller stores the address translation table for said area set to said first status, which has been generated before the initialization operation, to said table block, and generates the address translation table for said area set to said second status for each initialization operation.

2. The semiconductor integrated circuit device according to claim 1,
wherein said area set to said first status and said area set to said second status are provided in different strings, respectively.

3. The semiconductor integrated circuit device according to claim 1,
wherein said controller sets said area set to said first status to an arbitrary area in units of strings.

4. The semiconductor integrated circuit device according to claim 1,
wherein said controller performs the area setting for said area set to said first status based on a command input from the outside.

5. The semiconductor integrated circuit device according to claim 1,
wherein said controller allows access to said area set to said first status upon reading of the address translation table for said area set to said first status, which is stored in said table block.

6. The semiconductor integrated circuit device according to claim 1,
wherein the area set to the second status of said nonvolatile semiconductor memory is randomly divided into a first area and a second area, and
wherein said controller generates the address translation table for said first area for each initialization operation, and generates the address translation table for said second area based on a command input from the outside.

7. The semiconductor integrated circuit device according to claim 1,
wherein said controller receives a read command input from the outside to read the data of said area set to said first status during the generation of the address translation table in said area set to said second status, and performs the generation of said address translation table and the reading of data from said area set to said first status, in a time-sharing manner.

8. The semiconductor integrated circuit device according to claim 7,
wherein said controller generates the address translation table in said area set to said second status, in a second access for transferring the data read from said area set to said first status upon reception of the read command input from the outside, to the outside from a read buffer that temporality stores the data read from said nonvolatile semiconductor memory.

9. A method of generation of the address translation table, comprising the steps of:
randomly dividing a memory area of a nonvolatile semiconductor memory into an area set to a first status in which data is not allowed to be updated and an area set to a second status in which data is allowed to be updated;
generating, for said area set to said first status, an address translation table in which a logical address supplied from the outside is mapped to each physical address of said area set to said first status, before an initialization operation to store to said memory area; and
generating, for the area set to said second status, an address translation table for each initialization operation.

10. The method of generation of the address translation table according to claim 9, further comprising a step of:
performing the area settings for said first status and said area set to said second status to different strings, respectively.

11. The method of generation of the address translation table according to claim 9, further comprising a step of:
performing the area setting for said area set to said first status in units of strings.

12. The method of generation of the address translation table according to claim 9, further comprising a step of:
performing the area setting for said area set to said first status based on the command input from the outside.

13. The method of generation of the address translation table according to claim 9, further comprising the steps of:
in the initialization operation, reading the address translation table for said area set to said first status, which is stored in said memory area, to enable access to said area set to said first status, and then generating the address translation table for said area set to said second status.

14. The method of generation of the address translation table according to claim 9, further comprising the steps of:
randomly dividing said area set to said second status of said nonvolatile semiconductor memory into a first area and a second area;
generating the address translation table for said first area for each initialization operation; and
generating the address translation table for said second area based on a command input from the outside.

15. The method of generation of the address translation table according to claim 9, further comprising the steps of:
receiving a read command input from the outside to read the data of said area set to said first status during the generation of the address translation table in said area set to said second status; and
performing the generation of said address translation table and the reading of the data from said area set to said first status in a time-sharing manner.

16. The method of generation of the address translation table according to claim 15, further comprising a step of:
generating the address translation table in said area set to said second status, in a second access for transferring to the outside the data read from said area set to said first area upon reception of the read command input from the outside.
